(19) United States
(12) Patent Application Publication
(10) Pub. No.: US 2021/0132100 A1
(43) Pub. Date: May 6, 2021

(54) INERTIAL SENSOR, ELECTRONIC APPARATUS, AND VEHICLE

(71) Applicant: SEIKO EPSON CORPORATION, Tokyo (JP)

(72) Inventor: Fumiya Ito, Chikuma-shi (JP)

(21) Appl. No.: 17/083,767

(22) Filed: Oct. 29, 2020

(30) Foreign Application Priority Data
Oct. 31, 2019 (JP) 2019-198378

(51) Int. Cl. G01P 1/02; G01P 15/125; G01P 15/08

(52) U.S. Cl. CPC G01P 1/023; G01P 15/0802; G01P 15/125

(57) ABSTRACT

The inertial sensor includes a first substrate provided with an inertial sensor element, and a second substrate. The first substrate includes, in a plan view, a first area to be bonded to the second substrate, a second area which is located outside the first area, and is not bonded to the second substrate, and a third area which is located outside the second area, and is not bonded to the second substrate. The first substrate in the second area has a part thinner than a thickness of the first substrate in the third area.

The present application is based on, and claims priority from JP Application Serial Number 2019-198378, filed Oct. 31, 2019, the disclosure of which is hereby incorporated by reference herein in its entirety.

### BACKGROUND

### 1. Technical Field

The present disclosure relates to an inertial sensor, an electronic apparatus, a vehicle, and so on.

### 2. Related Art

An inertial sensor as an example of a three-axis acceleration sensor is housed inside a package together with a sensor substrate and an integrated circuit (IC) as shown in JP-A-2019-39885 (Document 1). In Document 1, the sensor substrate is bonded to a bottom surface of the package with a resin adhesive. The integrated circuit is disposed on the sensor substrate.

Since the sensor substrate supports an inertial sensor element, when warpage occurs in the sensor substrate, the positional relationship of the inertial sensor element also changes. For example, there is known a capacitance-type sensor which uses a change in capacitance due to a variation in the gap between the electrodes for the detection of the inertial amount using the principle of a capacitor. The inter-electrode gap of the inertial sensor element changes due to the warpage of the sensor substrate, and thus, the sensor output changes. Further, even in other inertial sensors, due to the warpage of the sensor substrate, the resistance value changes in a piezoresistive type, a pressure due to the warpage is applied in a piezoelectric type, or the frequency changes in a vibration-type sensor, and thus, the output of the inertial sensor element changes.

Further, when the state in which the warpage occurs in the sensor substrate is kept, the amount of the warpage gradually changes due to a creep phenomenon. As a result, since the sensor output continues to change, stability, repeatability, or the stability and the repeatability cannot be maintained.

### SUMMARY

An aspect of the present disclosure relates to an inertial sensor including a first substrate provided with an inertial sensor element, and a second substrate configured to support the first substrate, wherein the first substrate includes, in a plan view, a first area to be bonded to the second substrate, a second area which is located outside the first area so as to have contact with a contour of the first area, and is not bonded to the second substrate, and a third area which is located outside the second area so as to have contact with a contour of the second area, and is not bonded to the second substrate, and the first substrate in the second area has a part thinner than a thickness of the first substrate in the third area.

### BRIEF DESCRIPTION OF THE DRAWINGS

FIG. 1 is a perspective view showing a schematic internal structure of a package of an inertial sensor according to a first embodiment of the present disclosure.

FIG. 2 is a diagram showing an internal structure of the inertial sensor at a position of the line A-A in FIG. 1.

FIG. 3 is a diagram for explaining a displacement in a Z direction and an amount of warpage of a sensor substrate in FIG. 1.

FIG. 4 is a diagram showing shape parameters of the sensor substrate in FIG. 1.

FIG. 5 is a characteristic diagram showing warpage in the first embodiment according to the present disclosure, Comparative Example 1, and Comparative Example 2.

FIG. 6 is a characteristic diagram showing the magnitude of the warpage varying depending on the size of a first area.

FIG. 7 is a characteristic diagram showing the magnitude of the warpage varying depending on the size of a second area.

FIG. 8 is a diagram showing a modified example of the sensor substrate.

FIG. 9 is a diagram showing another modified example of the sensor substrate.

FIG. 10 is a diagram showing still another modified example of the sensor substrate.

FIG. 11 is a diagram schematically showing an inertial sensor according to a second embodiment of the present disclosure.

FIG. 12 is a schematic diagram of the inertial sensor according to the second embodiment of the present disclosure.

FIG. 13 is a schematic diagram of an inertial sensor according to a third embodiment of the present disclosure.

FIG. 14 is a block diagram of an electronic apparatus according to another embodiment of the present disclosure.

FIG. 15 is a diagram showing an example of a vehicle according to still another embodiment of the present disclosure.

FIG. 16 is a block diagram showing a configuration example of the vehicle.

### DESCRIPTION OF EXEMPLARY EMBODIMENTS

The present embodiments will hereinafter be described. It should be noted that the present embodiments described below do not unreasonably limit the contents set forth in the appended claims. Further, all of the constituents described in the present embodiments are not necessarily essential elements.

### 1. Inertial Sensor

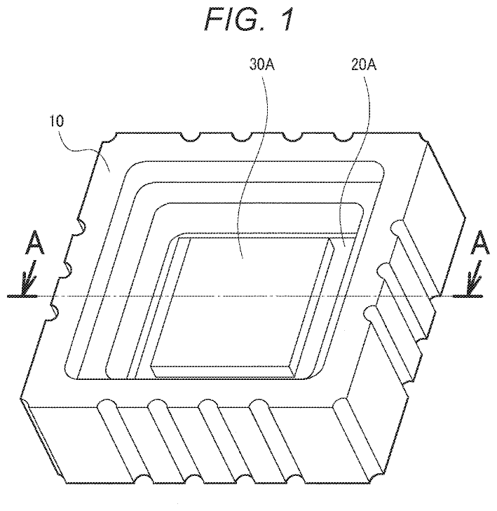

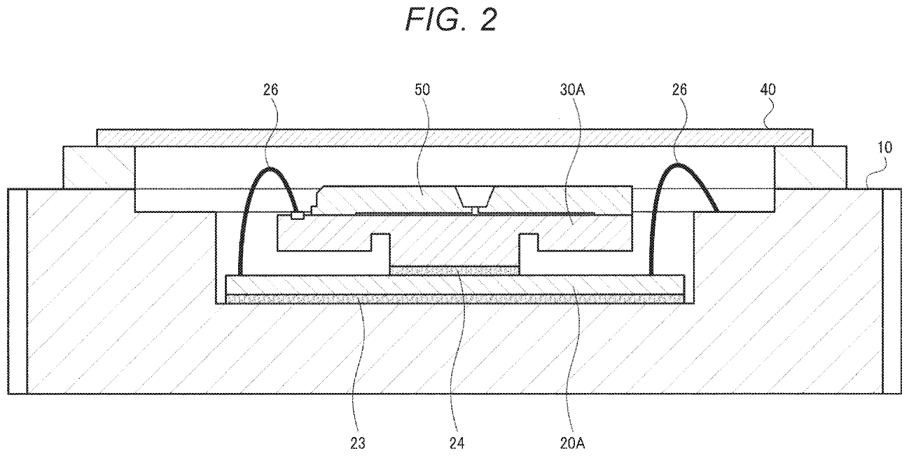

In FIG. 1 and FIG. 2, inside the package 10 having an opening in the upper part thereof, there are disposed an integrated circuit (IC) 20A and a sensor substrate 30A. In the present embodiments, the sensor substrate 30A is a first substrate having an inertial sensor element, and the integrated circuit 20A is a second substrate for supporting the first substrate. The sensor substrate 30A is, for example, a glass substrate. For example, the sensor substrate 30A is a glass substrate including alkali metal ions such as borosilicate glass. The material of the sensor substrate 30A is not limited to the glass material, but can also be, for example, a silicon material high in resistance, glass ceramic such as low-temperature co-fired ceramic, or alumina ceramic.

As shown in FIG. 2, to the bottom part of the package 10, there is bonded the integrated circuit 20A with, for example, a resin adhesive 23. On the upper surface of the integrated circuit 20A, there is bonded the sensor substrate 30A with, for example, a resin adhesive 24. Pads of the integrated circuit 20A are electrically coupled to pads provided to the sensor substrate 30A and the package 10 with bonding wires 26, respectively. An upper opening of the package 10 is closed with a lid 40. It should be noted that the package 10 is made of ceramic such as aluminum oxide in the present embodiment, but can also be configured using metal or the like in addition to an insulating body such as glass or resin besides the ceramic.

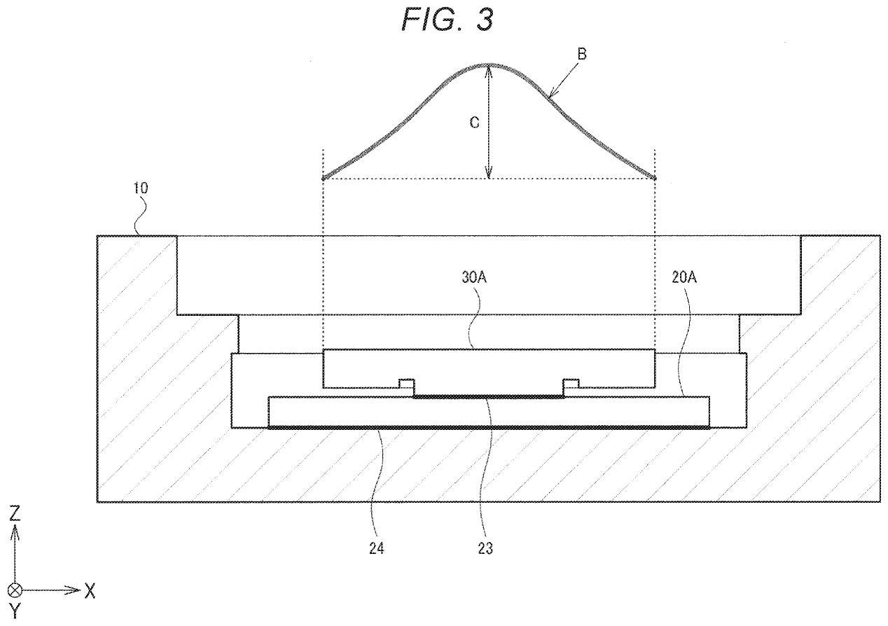

In FIG. 3, there are defined three axes perpendicular to each other as an X axis, a Y axis, and a Z axis. The Z-axis direction corresponds to a stacking direction of the integrated circuit 20A and the sensor substrate 30A, and two axes perpendicular to each other on a two-dimensional plane perpendicular to the Z axis are defined as the X axis and the Y axis. Although not shown in the drawings, the sensor substrate 30A is provided with, for example, a three-axis acceleration sensor element or a three-axis gyro sensor element, or the three-axis acceleration sensor element and the three-axis gyro sensor element mounted thereon in the central area thereof as the inertial sensor elements. Each of the inertial sensor elements is constituted by an element of a capacitance type, a piezoelectric type, a piezoresistive type, a vibration type, or the like.

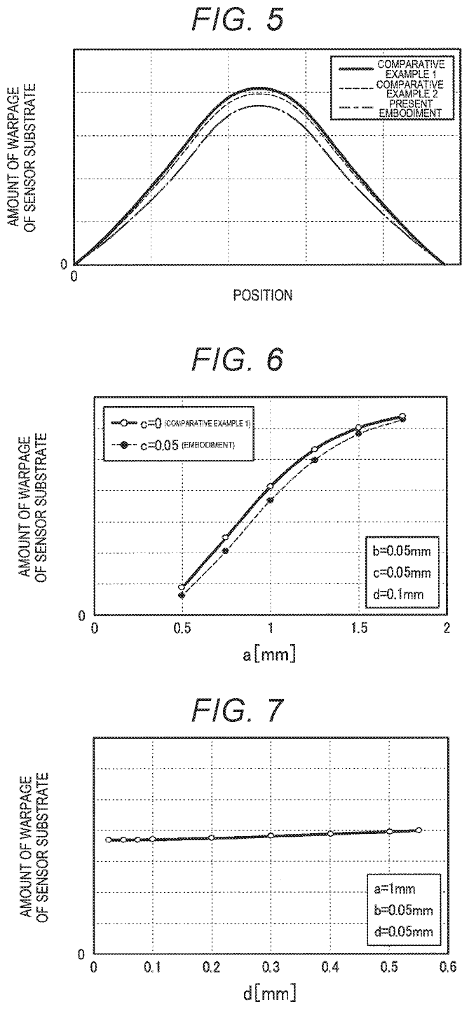

The curve B in FIG. 3 represents a displacement in the Z direction occurring each of the positions in the sensor substrate 30A due to a temperature variation and so on. In particular, on the interface between the integrated circuit 20A and the sensor substrate 30A different in thermal expansion coefficient from each other, there occurs thermal stress/strain due to the temperature variation, and thus, the sensor substrate 30A is displaced in the Z direction. The displacement in the Z direction of the sensor substrate 30A has positional dependence, and the displacement is large at the center of the sensor substrate 30A, and is small in the peripheral edges as shown in FIG. 3. It should be noted that the reason therefore will be described later using FIG. 5. The maximum displacement C in the Z direction of the sensor substrate 30A is defined as an “amount of warpage.”

### 1.1. First Embodiment

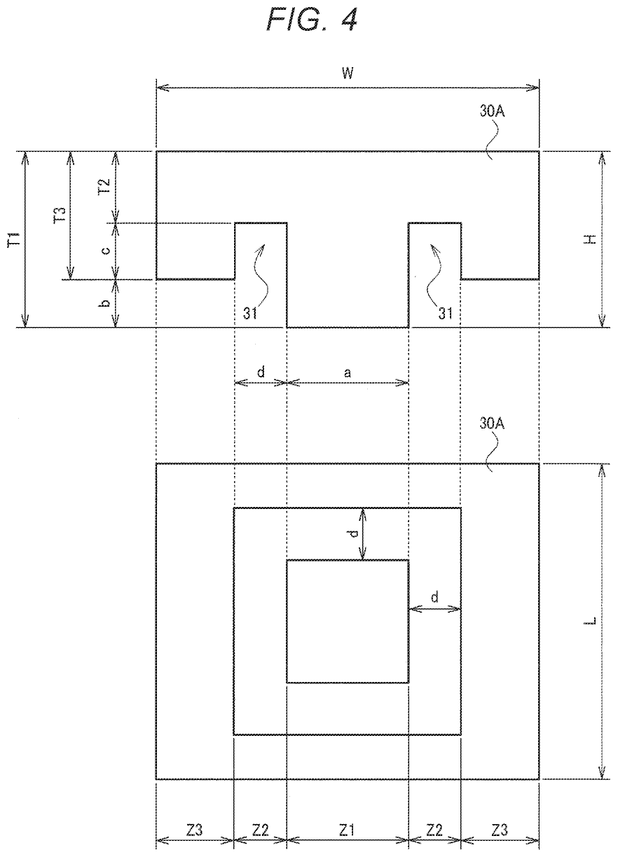

FIG. 4 shows shape parameters of the sensor substrate 30A according to a first embodiment. The sensor substrate 30A shown in FIG. 4 has, for example, a rectangular shape in a plan view, and for example, the width W=1 through 10 mm, the length L=1 through 10 mm, and the height (thickness) H=0.1 through 5 mm are assumed.

As shown in FIG. 4, the sensor substrate 30A is zoned into three areas Z1, Z2, and Z3 in the plan view. The first area Z1 of the sensor substrate 30A is an area to be bonded to the integrated circuit 20A with the resin adhesive 23 as shown in FIG. 2. The second area Z2 of the sensor substrate 30A is located outside the first area Z1 so as to have contact with the contour of the first area Z1, and is not bonded to the integrated circuit 20A. The third area Z3 is located outside the second area Z2 so as to have contact with the contour of the second area Z2, and is not bonded to the integrated circuit 20A. In the present embodiment, in the plan view, the second area Z2 is disposed so as to surround the first area Z1, and the third area Z3 is disposed so as to surround the second area Z2. This is not a limitation, and in FIG. 3, the first area Z1 can be formed throughout the entire length L, and in that case, the second area Z2 is disposed so as to have contact with the second area Z1 throughout the entire length L, and the third area Z3 is disposed so as to have contact with the second area Z2 throughout the entire length L.

As shown in FIG. 4, the sensor substrate 30A is different in thickness (height) between the three areas Z1, Z2, and Z3. When defining the respective thicknesses of the first through third areas Z1, Z2, and Z3 as T1, T2, and T3 as shown in FIG. 4, T2<T3<T1 becomes true. In the present embodiment, in order to make T2<T3 true, the second area Z2 is formed of a groove 31 opening in the surface of the sensor substrate 30A opposed to the integrated circuit 20A. Taking the fact that the first area Z1 of the sensor substrate 30A is bonded to the flat upper surface of the integrated circuit 20A as shown in FIG. 2 into consideration, the second area Z2 is separated from the flat upper surface of the integrated circuit 20A with a first distance (T1-T2), and the third area Z3 is separated from the flat upper surface of the integrated circuit 20A with a second distance (T1-T3). Thus, the second area Z2 and the third area Z3 become not to be bonded to the flat upper surface of the integrated circuit 20A. Here, since T2<T3 is true, the first distance (T1-T2) is longer than the second distance (T1-T3).

### 1.2. Evaluation of First Embodiment

In order to explain the advantage of the present embodiment, comparison with Comparative Example 1 and Comparative Example 2 will be described. The shape parameters “a,” “b,” and “c” of the sensor substrate described with reference to FIG. 4 are set as in the following table. Here, Comparative Example 1 and Comparative Example 2 are the same in the point that the groove 31 shown in FIG. 4 is not provided, and are different in the dimension “b” from each other. Comparative Example 1 smaller in dimension “b” is thicker in thickness T2 (=T3) common to the second and third areas than Comparative Example 2 larger in dimension “b.” Further, the width “d” of the groove 31 in the present embodiment is set as d=0.1 mm.

TABLE 1

| | Present | Comparative | Comparative |
|---|---|---|---|
| | Embodiment | Example 1 | Example 2 |
| a | 1.0 mm | 1.0 mm | 1.0 mm |
| b | 0.1 mm | 0.05 mm | 0.1 mm |
| c | 0.1 mm | 0 | 0 |

Regarding the present embodiment, Comparative Example 1, and Comparative Example 2, the result of a simulation related to the displacement in the Z direction of the sensor substrate is shown in FIG. 5. FIG. 5 shows the result of the simulation related to the displacement in the Z direction of the sensor substrate when applying a temperature variation of 125° C. to cause the thermal stress/strain on the interface between the sensor substrate 30A and the integrated circuit 20A. As shown in FIG. 5, it is understood that the present embodiment is smaller in warpage of the sensor substrate than Comparative Example 1 and Comparative Example 2. Further, as shown in FIG. 5, it is understood that Comparative Example 1 is larger in warpage than Comparative Example 2.

It is conceivable that the result of the simulation shown in FIG. 5 can be explained on the following grounds. Firstly, although there is a difference in presence or absence of the groove 31, the present embodiment and Comparative Example 1, Comparative Example 2 have a T-shaped common structure in which the second area Z2 and the third area Z3 protrude from both sides of the end parts in the Z direction of the first area Z1 in a cross-sectional view. Further, the present embodiment and Comparative Example 1, Comparative Example 2 are the same in dimension a proportional to the junction area between the sensor substrate and the integrated circuit as each other, and are therefore equal in thermal stress/strain caused by the difference in thermal expansion coefficient between the sensor substrate and the integrated circuit.

(1) The thermal stress propagates the first area Z1 out of the T-shaped common structure, and then propagates from the end parts in the Z direction of the first area Z1 to the second area Z2 and the third area Z3 located on both sides thereof (hereinafter referred to as factor (1)). Due to the factor (1), in FIG. 3 and FIG. 5, in the present embodiment and Comparative Example 1, Comparative Example 2, the displacement in the Z direction becomes large in the central area of the sensor substrate, and becomes small in the peripheral edge areas thereof. Due to the factor (1), it is possible to reduce the displacement in the Z direction compared to what bonds the entire area of the first area Z1, the second area Z2, and the third area Z3 thereto. This is because as described later in detail, the aspect ratio becomes high in the first area Z1 due to the T-shaped structure to make the warpage small, and the warpage becomes small in the second area Z2 and the third area Z3 on the grounds that the thermal stress propagates thereto via the first area Z1.

In addition, as the reason that the displacement (the warpage) in the Z direction is different between the present embodiment and Comparative Example 1, Comparative Example 2, the following three additional factors (2) through (4) are conceivable on the grounds that in the present embodiment, the groove 31 opening in the surface of the sensor substrate 30A opposed to the integrated circuit 20A is formed in the second area Z2.

(2) In the present embodiment, by providing the groove 31 opening in the surface of the sensor substrate 30A opposed to the integrated circuit 20A, the aspect ratio of the shaft part specified by the width “a” and the length (b+c) is defined as (b+c)/a in the first area Z1 of the sensor substrate 30A. In contrast, in Comparative Example 1 and Comparative Example 2 not provided with the groove 31, the aspect ratio in the shaft part specified by the width “a” and the length “b” is defined as b/a. Therefore, in the present embodiment, by providing the groove 31 opening in the surface of the sensor substrate 30A opposed to the integrated circuit 20A, it is possible to make the aspect ratio higher as much as the dimension “c” than in Comparative Example 1 and Comparative Example 2. In general, providing the width “a” is the same, the larger the length (the thickness) in the Z direction is, namely the higher the aspect ratio is, the higher the capacity with respect to the displacement in the Z direction is. In FIG. 5, the reason that the displacement in the Z direction becomes smaller than in Comparative Example 1 and Comparative Example 2 in the central area (the first area Z1) of the sensor substrate 30A in the present embodiment is that the aspect ratio is higher. In Comparative Example 2 larger in the value of the dimension “b” than Comparative Example 1, since the aspect ratio is higher than in Comparative Example 1, the displacement in the Z direction is smaller in the central area (the first area Z1) than in Comparative Example 1 as shown in FIG. 5.

(3) The distance in which the thermal stress propagates from the first area Z1 to the third area Z3 through the second area Z2 becomes longer than in Comparative Example 1 and Comparative Example 2.

(4) In the process in which the thermal stress is propagated from the first area Z1 to the third area Z3, the thermal stress propagates through the second area Z2 narrower in entrance than Comparative Example 1 and Comparative Example 2 since the thickness T2 is thinner.

Due to these two factors (3), (4), the thermal stress becomes difficult to propagate from the first area Z1 to the third area Z3, and as a result, the displacement in the Z direction in the second area Z2 and the third area Z3 becomes smaller than Comparative Example 1 and Comparative Example 2 as shown in FIG. 5.

Due to the factor (4), it is possible to explain the phenomenon that the displacement in the Z direction in the second area Z2 and the third area Z3 becomes larger in Comparative Example 1 than in Comparative Example 2. That is, the reason therefor is that in Comparative Example 1 smaller in dimension “b” in FIG. 4, since the thickness T2 (=T3) common to the area Z2 and the area Z3 is thicker than in Comparative Example 2, the thermal stress is apt to be propagated from the first area Z1 to the third area Z3 via the second area Z2 large in entrance.

FIG. 6 shows a result of the simulation of measuring the warpage of the sensor substrate in the present embodiment and Comparative Example 1 using the dimension “a” of the first area Z1 as a parameter. It is understood that the smaller the dimension “a” becomes, the smaller the warpage of the sensor substrate becomes as shown in FIG. 6. This shows that when the dimension “a” proportional to the junction area between the sensor substrate and the integrated circuit decreases, the aspect ratio increases as described above, and therefore, the displacement in the Z direction decreases. It should be noted that by providing the groove 31 opening in the surface of the sensor substrate 30A opposed to the integrated circuit 20A, it is possible to make the aspect ratio (b+c)/a higher as much as the dimension “c” than in Comparative Example 1. It should be noted that it is possible to provide the groove 31 to the surface on the opposite side to the surface on which the sensor substrate 30A is opposed to the integrated circuit 20A, and in this case, it is possible to decrease the displacement in the Z direction due to at least the factors (1), (4) although the factors (2), (3) are not true.

FIG. 7 shows a result of the simulation of measuring the warpage of the sensor substrate in the present embodiment using the dimension “d” (the width of the groove 31) of the second area Z2 as a parameter. The minimum value and the maximum value corresponding to the scale of the vertical axis in FIG. 7 and the minimum value and the maximum value corresponding to the scale of the vertical axis in FIG. 6 are set to the same values, respectively. It is understood that the degree of correlation of the width dimension “d” of the groove 31 with respect to the amount of warpage is relatively low just by the groove 31 existing in the second area Z2 as shown in FIG. 7. Therefore, the superiority in providing the groove 31 in the present embodiment is understood.

### 1.3. Modified Examples of First Embodiment

The second area Z2 is not limited to the groove 31 constant in depth as shown in FIG. 4, but can be implemented with a modification as shown in FIG. 8 or FIG. 9. FIG. 8 shows an example having a part different in groove depth such as the groove 32 having a tilted wall surface. It should be noted that although in FIG. 8, there is shown the tilted surface tilted from a position having contact with the third area Z3, it is possible to provide a tilted surface tilted from a position having contact with the first area Z1 instead thereof, or in addition thereto. FIG. 9 shows an example having a part different in groove depth such as the groove 33 having a stepped surface. In either case, it is sufficient for the sensor substrate 30A in the second area Z2 to have the thickness T2 at the maximum depth position of the grooves 32, 33 thinner than the thickness T3 of the sensor substrate 30A in the third area Z3. This is because, the warpage can thus be reduced due to the factors (1) through (4) described above.

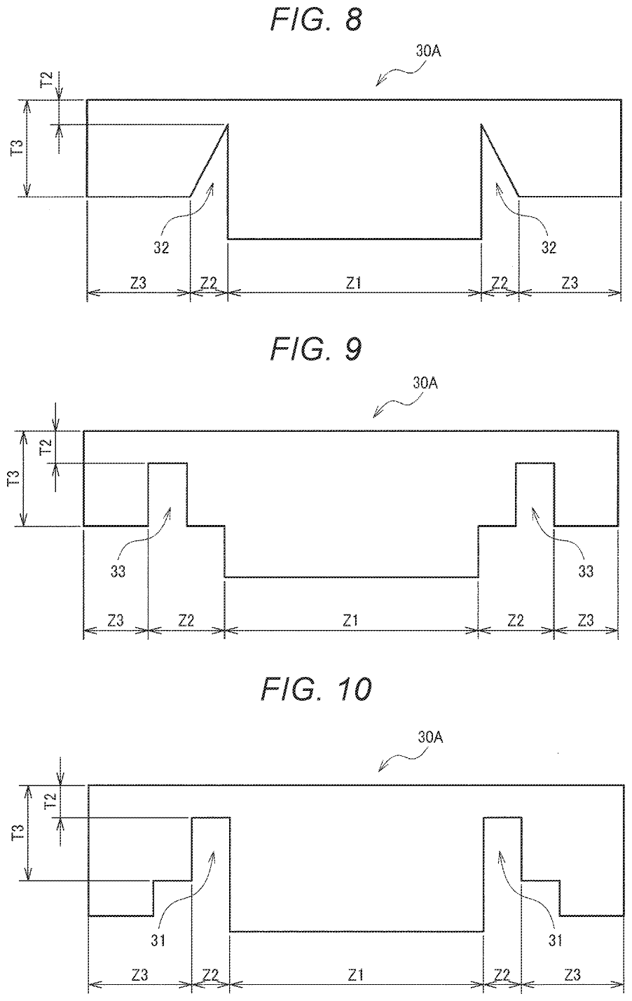

The third area Z3 can have a part different in thickness as shown in FIG. 10 instead of the constant thickness T3 as shown in FIG. 4. In the example shown in FIG. 10, a stepped surface is forming in the third area Z3. In this case, it is sufficient for the thickness T2 of the first substrate 30A in the second area Z2 to be thinner than the thickness T3 of the substrate 30A at the side having contact with the second area Z2 out of the third area Z3. This is because, the warpage can thus be reduced due to the factors (1) through (4) described above.

### 2. Second Embodiment

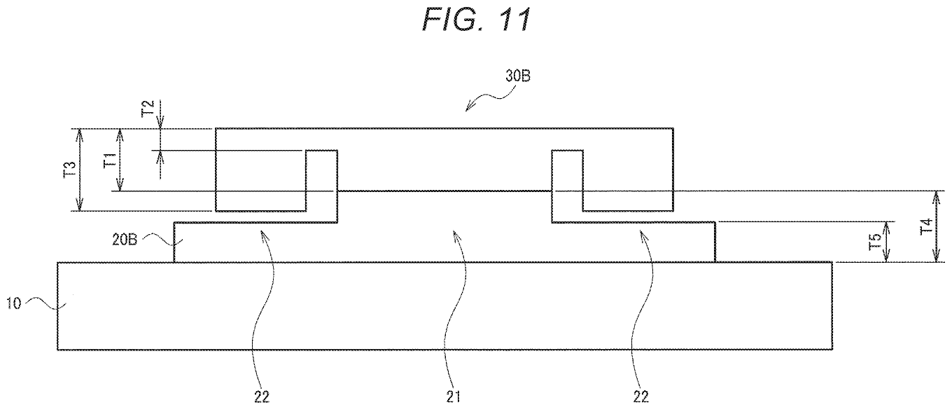

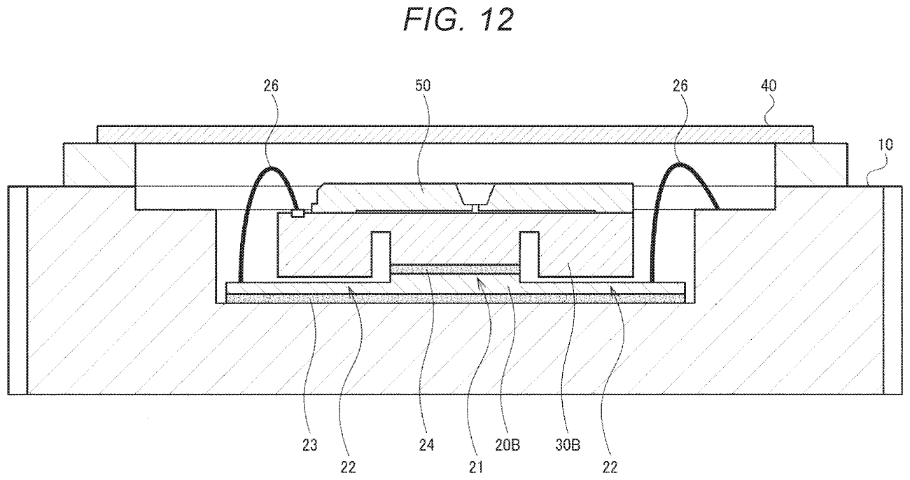

FIG. 11 and FIG. 12 are each a schematic diagram of an inertial sensor according to a second embodiment. The point in which FIG. 11 and FIG. 12 are different from FIG. 4 is that in an integrated circuit 20B, a central area 21 to be bonded to the first area Z1 of a first substrate 30B protrudes from a peripheral edge area 22 opposed to the second area Z2 and the third area Z3 of the first substrate 30B. In other words, as shown in FIG. 11, T4>T5 is true. Also in this case, the thickness T2 of the sensor substrate 30B in the second area Z2 is thinner than the thickness T3 of the sensor substrate 30B in the third area Z3. Thus, the warpage of the sensor substrate 30B decreases due to the factors (1) through (4) described above. Further, in the second embodiment, as shown in FIG. 11, the thickness T1 of the sensor substrate 30B in the first area Z1 becomes thinner than the thickness T3 of the sensor substrate 30B in the third area Z3 and thicker than the thickness T2 of the sensor substrate 30B in the second area Z2. Since the integrated circuit 20B has the central area 21 thus protruding, it is possible to thin the thickness T1 of the sensor substrate 30B in the first area Z1.

### 3. Third Embodiment

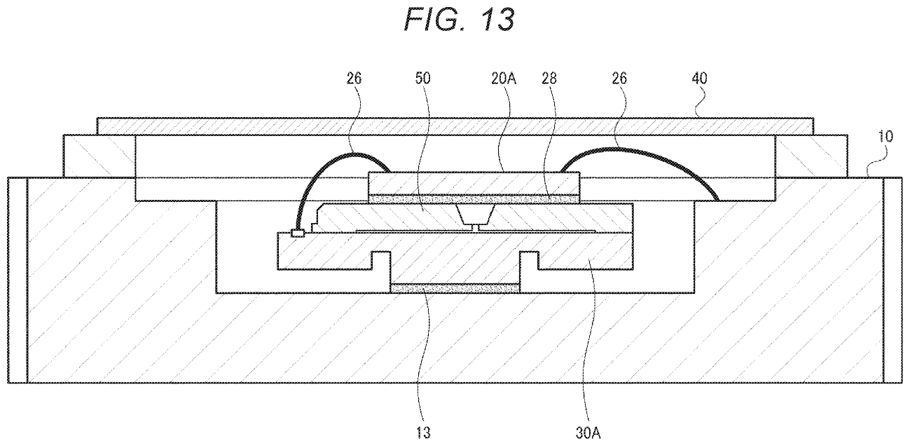

FIG. 13 is a schematic diagram of an inertial sensor according to a third embodiment. The point in which FIG. 13 is different from FIG. 4 is that the sensor substrate 30A is bonded to the bottom part of the package 10 with, for example, a resin adhesive 13 as shown in FIG. 13. On the upper surface of the lid 50 of the sensor substrate 30A, there is bonded the integrated circuit 20A with, for example, a resin adhesive 28. Likewise in FIG. 4, the pads of the integrated circuit 20A are electrically coupled to the pads provided to the sensor substrate 30A and the package 10 with the bonding wires, respectively, and the upper part opening of the package 10 is closed with the lid 40.

Also in the third embodiment, the sensor substrate 30A corresponds to the first substrate having the inertial sensor element. However, in the third embodiment, unlike the first embodiment, the package 10 corresponds to the second substrate for supporting the first substrate (the sensor substrate 30A). In this case, since the sensor substrate 30A as the first substrate has the structure shown in FIG. 4, it becomes difficult for the thermal stress due to the difference in thermal expansion coefficient between the package 10 and the sensor substrate 30A to propagate to the third area Z3 of the sensor substrate 30A. Thus, the warpage of the sensor substrate 30A is reduced. It should be noted that in the third embodiment, when a central area of the bottom part of the package 10 is made to protrude similarly to the integrated circuit 20B in the second embodiment, it is possible to use the sensor substrate 30B shown in FIG. 11 and FIG. 12 instead of the sensor substrate 30A shown in FIG. 13.

### 4. Electronic Apparatus, Vehicle

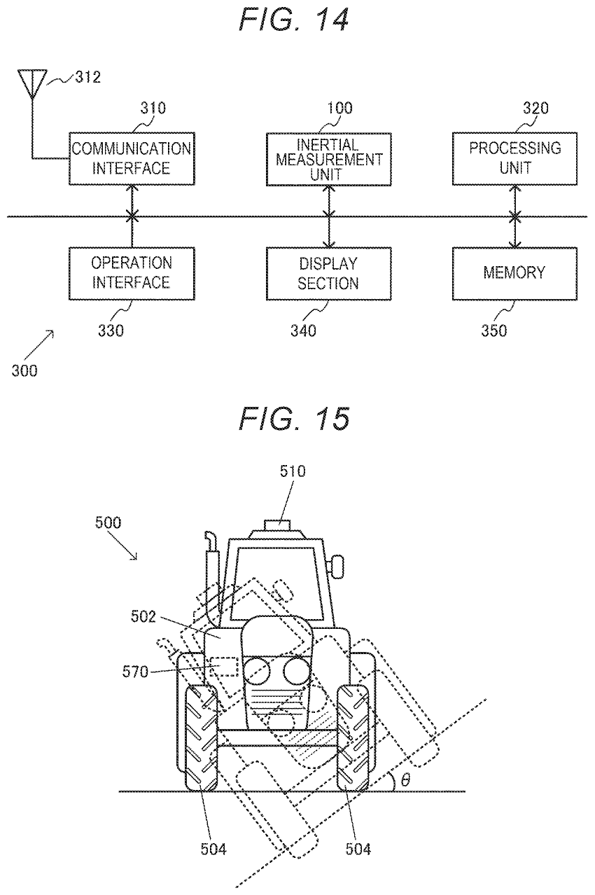

FIG. 14 is a block diagram showing a configuration example of an electronic apparatus 300 according to the present embodiment. The electronic apparatus 300 includes an inertial measurement unit 100 having the inertial sensor according to any of the embodiments described above, and a processing unit 320 for performing processing based on the measurement result of the inertial measurement unit 100. Further, the electronic apparatus 300 can include a communication interface 310, an operation interface 330, a display section 340, a memory 350, and an antenna 312.

The communication interface 310 is, for example, a wireless circuit, and performs a process of receiving data from the outside and transmitting data to the outside via the antenna 312. The processing unit 320 performs a control process of the electronic apparatus 300, a variety of types of digital processing of the data transmitted or received via the communication interface 310. Further, the processing unit 320 performs the processing based on the measurement result of the inertial measurement unit 100. Specifically, the processing unit 320 performs signal processing such as a correction process or a filter process on the output signal as the measurement result of the inertial measurement unit 100, or performs a variety of control processes with respect to the electronic apparatus 300 based on the output signal. The function of the processing unit 320 can be realized by a processor such as an MPU or a CPU. The operation interface 330 is for the user to perform an input operation, and can be realized by operation buttons, a touch panel display, or the like. The display section 340 is for displaying a variety of types of information, and can be realized by a display using a liquid crystal, an organic EL, or the like. The memory 350 is for storing the data, and the function thereof can be realized by a semiconductor memory such as a RAM or a ROM, or the like.

It should be noted that the electronic apparatus 300 according to the present embodiment can be applied to a variety of equipment such as an in-car apparatus, a video-related apparatus such as a digital still camera or a video camera, a wearable apparatus such as a head-mounted display device or a timepiece-related apparatus, an inkjet-type ejection device, a robot, a personal computer, a portable information terminal, a printer, a projection apparatus, a medical instrument, or a measurement instrument. The in-car apparatus is a car navigation system, an apparatus for automated driving, or the like. The timepiece-related apparatus is a timepiece, a smart watch, or the like. As the inkjet-type ejection device, there can be cited an inkjet printer and so on. The portable information terminal is a smartphone, a cellular phone, a portable gaming device, a notebook PC, a tablet terminal, or the like.

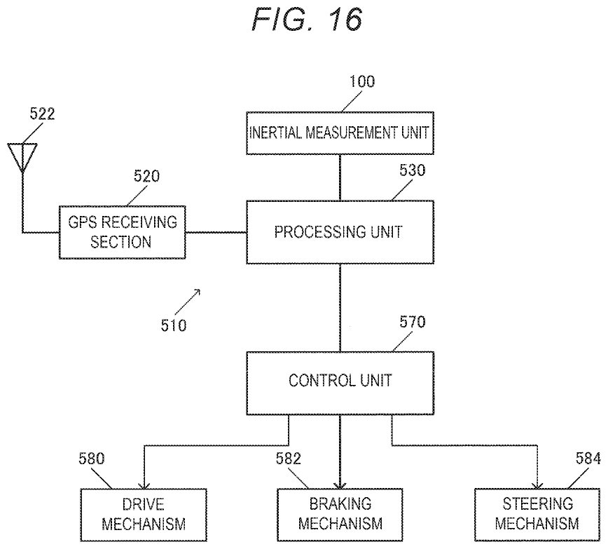

FIG. 15 shows an example of a vehicle 500 in which the inertial measurement unit 100 according to the present embodiment is used. FIG. 16 is a block diagram showing a configuration example of the vehicle 500. As shown in FIG. 16, the vehicle 500 according to the present embodiment includes the inertial measurement unit 100 and a processing unit 530 for performing processing based on the measurement result of the inertial measurement unit 100.

Specifically, as shown in FIG. 15, the vehicle 500 has a car body 502 and wheels 504. Further, a positioning unit 510 is installed in the vehicle 500. Further, a control unit 570 for performing vehicle control and so on is disposed inside the vehicle 500. Further, as shown in FIG. 16, the vehicle 500 has a drive mechanism 580 such as an engine or a motor, a braking mechanism 582 such as a disk brake or a drum brake, and a steering mechanism 584 realized by a steering wheel, a steering gearbox, and the like. As described above, the vehicle 500 is an apparatus or a unit which is provided with the drive mechanism 580, the braking mechanism 582, and the steering mechanism 584, and moves on the land, in the air, or on the sea. It should be noted that as the vehicle 500, there can be cited an automobile such as a four-wheeled vehicle or a motor bike, a bicycle, an electric train, an airplane, a ship, and so on, but in the present embodiment, the description will be presented citing the four-wheeled vehicle as an example.

The positioning unit 510 is a unit which is installed in the vehicle 500 to perform the positioning of the vehicle 500. The positioning unit 510 includes the inertial measurement unit 100 and the processing unit 530. Further, it is possible for the positioning unit 510 to include a GPS receiving section 520 and an antenna 522. The processing unit 530 as a host device receives acceleration data and angular velocity data as the measurement result of the inertial measurement unit 100, and then performs the inertial navigation arithmetic processing on these data to output inertial navigation positioning data. The inertial navigation positioning data is data representing the acceleration and the attitude of the vehicle 500.

The GPS receiving section 520 receives a signal from a GPS satellite via the antenna 522. The processing unit 530 obtains the GPS positioning data representing the position, the speed, and the azimuth of the vehicle 500 based on the signal received by the GPS receiving section 520. Further, the processing unit 530 calculates what position on the land the vehicle 500 is running using the inertial navigation positioning data and the GPS positioning data. For example, even when the position of the vehicle 500 included in the GPS positioning data is the same, when the attitude of the vehicle 500 is different due to the influence of the tilt (θ) of the land and so on as shown in FIG. 15, it results in that the vehicle 500 is running at a different position on the land. Therefore, it is unachievable to calculate the accurate position of the vehicle 500 with the GPS positioning data alone. Therefore, the processing unit 530 calculates what position on the land the vehicle 500 is running using in particular the data related to the attitude of the vehicle 500 out of the inertial navigation positioning data.

The control unit 570 performs the control of the drive mechanism 580, the braking mechanism 582, and the steering mechanism 584 of the vehicle 500. The control unit 570 is a controller for the vehicle control, and performs a variety of types of control such as the vehicle control and the automated driving control.

The vehicle 500 according to the present embodiment includes the inertial measurement unit 100 and the processing unit 530. The processing unit 530 performs a variety of processes as described above to obtain the information of the position and the attitude of the vehicle 500 based on the measurement result from the inertial measurement unit 100. For example, the information of the position of the vehicle 500 can be obtained based on the GPS positioning data and the inertial navigation positioning data as described above. Further, the information of the attitude of the vehicle 500 can be obtained based on, for example, the angular velocity data included in the inertial navigation positioning data. Further, the control unit 570 performs the control of the attitude of the vehicle 500 based on the information of the attitude of the vehicle 500 obtained by, for example, the processing by the processing unit 530. This control of the attitude can be realized by, for example, the control unit 570 controlling the steering mechanism 584. Alternatively, in the control such as slip control for stabilizing the attitude of the vehicle 500, it is possible for the control unit 570 to control the drive mechanism 580 or to control the braking mechanism 582. According to the present embodiment, since it is possible to accurately obtain the information of the attitude obtained by the output signal of the inertial measurement unit 100, it is possible to realize the appropriate attitude control and so on of the vehicle 500. Further, in the present embodiment, the automated driving control of the vehicle 500 can also be realized. In this automated driving control, there are used the monitoring result of a surrounding object, map information, driving route information, and so on in addition to the information of the position and attitude of the vehicle 500.

### 5. Conclusion of Embodiments

As described hereinabove, the inertial sensor according to the present embodiments has the first substrate 30A, 30B provided with the inertial sensor element, and the second substrate 20A, 20B for supporting the first substrate as shown in FIG. 4, and FIG. 8 through FIG. 12. In the plan view, the first substrate has the first area Z1 to be bonded to the second substrate, the second area Z2 located outside the first area so as to have contact with the contour of the first area, and not bonded to the second substrate, and the third area Z3 located outside the second area so as to have contact with the contour of the second area, and not bonded to the second substrate, and the first substrate in the second area has the part 31 through 33 thinner than the thickness of the first substrate in the third area (T2<T3).

According to the present embodiment, the thermal stress generated on the interface between the first area Z1 of the first substrate 30A, 30B and the second substrate 20A, 20B different in thermal expansion coefficient from each other becomes difficult to be propagated in the part 31 through 33 thin in thickness in the second area Z2 when propagating from the first area Z1 of the first substrate 30A, 30B to the third area Z3 via the second area Z2. Thus, the warpage of the first substrate 30A, 30B decreases due to the factor (4) described above. Further, by limiting the junction area of the first substrate to the first area Z1, the thermal stress is limited to one generated on the interface between the first substrate 30A, 30B and the second substrate 20A, 20B, and thus, the warpage of the first substrate 30A, 30B is decreased due to the factor (1) described above.

In the present embodiment, as shown in FIG. 4, it is possible for the second area Z2 to surround the first area Z1 in the plan view, and it is possible for the third area Z3 to surround the second area Z2 in the plan view. Besides the above, it is possible for the first area Z1 to be formed throughout the entire length L from one end of the first substrate 30A, 30B to the other end thereof.

As shown in FIG. 4, and FIG. 8 through FIG. 12, in the present embodiments, it is possible for the second area Z2 to include the groove 31 opening in the surface of the first substrate 30A, 30B opposed to the second substrate 20A, 20B. Thus, it is possible to further decrease the warpage of the first substrate 30A, 30B due to the factors (1) through (4).

In the present embodiment, as shown in FIG. 8 and FIG. 9, it is possible for the groove 32, 33 to have the part different in depth, and thus it is possible for the first substrate 30A, 30B in the second area Z2 to be made thinner than the thickness of the first substrate 30A, 30B in the third area Z3 at the maximum depth position of the groove. Thus, the factor (2) is ensured, and it is possible to decrease the warpage of the first substrate 30A, 30B due to at least the factors (1), (4).

In the present embodiments, the second substrate 20A has the flat surface as the surface to be opposed to the first substrate 30A as shown in FIG. 2, and it is possible to make the first substrate 30A in the first area Z1 thicker than the thickness of the first substrate 30A in the second area Z2 and thicker than the thickness of the first substrate 30A in the third area Z3 (T1>T3>T2) as shown in FIG. 4.

Alternatively, in the present embodiment, as shown in FIG. 11 and FIG. 12, in the second substrate 20B, the central area 21 to which the first area Z1 of the first substrate 30B is bonded protrudes from the peripheral edge area 22 opposed to the second area Z2 and the third area Z3 of the first substrate 30B (T4>T5), and it is possible to make the thickness T1 of the first substrate 30B in the first area Z1 thinner than the thickness T3 of the first substrate 30B in the third area Z3, and thicker than the thickness T2 of the first substrate 30B in the second area Z2 (T3>T1>T2).

In the present embodiments, the first substrate 30A in the third area Z3 has the part different in thickness, and it is possible to make the first substrate 30A in the second area Z2 thinner than the thickness of the first substrate 30A at the side having contact with the second area Z2 out of the third area Z3 (FIG. 10). Thus, it is possible to decrease the warpage of the first substrate 30A, 30B due to at least the factors (1), (4).

In the present embodiments, it is possible for the first substrate 30A, 30B to be formed of the glass substrate, and it is possible for the second substrate 20A, 20B to be formed of the integrated circuit or the package (ceramic).

The electronic apparatus according to the present embodiment can be provided with the inertial sensor described above, and a control section for performing the control based on the detection signal output from the inertial sensor. By reducing the warpage generated in the sensor substrate of the inertial sensor, an error in the detection signal from the inertial sensor is reduced, and thus, the reliability of the control of the electronic apparatus is enhanced.

The vehicle according to the present embodiment can be provided with the inertial sensor described above, and an attitude control section for performing the control of the attitude based on the detection signal output from the inertial sensor. By reducing the warpage generated in the sensor substrate of the inertial sensor, an error in the detection signal from the inertial sensor is reduced, and thus, the reliability of the attitude control of the vehicle is enhanced.

What is claimed is:

1. An inertial sensor comprising:
a first substrate provided with an inertial sensor element; and
a second substrate configured to support the first substrate, wherein
the first substrate includes, in a plan view,
a first area to be bonded to the second substrate,
a second area which is located outside the first area, and is not bonded to the second substrate, and
a third area which is located outside the second area, and is not bonded to the second substrate, and
the first substrate in the second area has apart thinner than a thickness of the first substrate in the third area.

2. The inertial sensor according to claim 1, wherein
the second area surrounds the first area in the plan view, and
the third area surrounds the second area in the plan view.

3. The inertial sensor according to claim 1, wherein
the second area includes a groove in a surface of the first substrate opposed to the second substrate.

4. The inertial sensor according to claim 3, wherein
the groove includes a part different in depth, and
the first substrate in the second area is thinner than the thickness of the first substrate in the third area at a maximum depth position of the groove.

5. The inertial sensor according to claim 1, wherein
the second substrate has a flat surface as a surface opposed to the first substrate, and
the first substrate in the first area is thicker than a thickness of the first substrate in the second area, and thicker than the thickness of the first substrate in the third area.

6. The inertial sensor according to claim 1, wherein
in the second substrate, a central area to which the first area of the first substrate is bonded protrudes from a peripheral edge area opposed to the second area and the third area of the first substrate, and
a thickness of the first substrate in the first area is thinner than the thickness of the first substrate in the third area, and thicker than a thickness of the first substrate in the second area.

7. The inertial sensor according to claim 1, wherein
the first substrate in the third area has a part different in thickness, and
the first substrate in the second area is thinner than a thickness of the first substrate at a side having contact with the second area out of the third area.

8. The inertial sensor according to claim 1, wherein
the first substrate is a glass substrate.

9. The inertial sensor according to claim 1, wherein
the second substrate includes an integrated circuit.

10. An electronic apparatus comprising the inertial sensor according to claim 1.

11. A vehicle comprising the inertial sensor according to claim 1.
